(19) United States
(12) Patent Application Publication
(10) Pub. No.: US 2023/0206943 A1
(43) Pub. Date: Jun. 29, 2023

(54) AUDIO RECOGNIZING METHOD, APPARATUS, DEVICE, MEDIUM AND PRODUCT

(71) Applicant: Beijing Baidu Netcom Science Technology Co., Ltd., Beijing (CN)

(72) Inventors: Wenjie Li, Beijing (CN); Zhanjie Gao, Beijing (CN); Lei Jia, Beijing (CN)

(21) Appl. No.: 17/891,596

(22) Filed: Aug. 19, 2022

(30) Foreign Application Priority Data
Dec. 27, 2021 (CN) 2021116146304

(51) Int. Cl. G10L 25/93; G10L 25/03

(52) U.S. Cl. CPC G10L 25/93; G10L 25/03

(57) ABSTRACT

An audio recognizing method, including: performing acoustic feature prediction on the audio to be recognized to obtain first audio prediction result and an acoustic feature reference quantity for predicting an audio recognition result; obtaining second audio prediction result based on the acoustic feature reference quantity; and determining the audio recognition result of the audio to be recognized based on the first audio prediction result and the second audio prediction result, the audio recognition result including unvoiced sound or voiced sound. When determining that the audio is unvoiced sound or voiced sound, the first audio prediction result obtained by performing acoustic feature prediction on the audio to be recognized is used, and the second audio prediction result is obtained in combination with other acoustic feature reference quantities, thereby making the determination result of unvoiced sound or voiced sound of the audio more accurate, to improve the audio quality in speech processing.

### CROSS-REFERENCE TO RELATED APPLICATION

This application claims priority to Chinese Patent Application No. 202111614630.4 filed on Dec. 27, 2021, the disclosure of which is hereby incorporated by reference in its entirety.

### TECHNICAL FIELD

The present disclosure relates to the field of computers, and more specifically to the technical field of speech processing, deep learning, artificial intelligence.

### BACKGROUND

With the development of science and technology, computers have been more and more used to process audio data and the like. Speech enhancement, speech synthesis, etc. are of great significance to the determination of voiced sound and unvoiced sound of audio data during the processing of audio data. The unvoiced sound is the sound that is produced without vibration of the vocal cords, and the voiced sound is the sound that is produced with vibration of the vocal cords.

When there is a problem with the determination result of the voiced sound and unvoiced sound, the processed sound will have speed change and pitch change, and the synthesized sound will have problems such as mute, broken sound, falsetto, etc., which affects the processing effect of the sound.

### SUMMARY

The present disclosure provides an audio recognizing method, apparatus, device, medium and product.

According to an aspect of the present disclosure, there is provided an audio recognizing method, including: performing acoustic feature prediction on audio to be recognized to obtain a first audio prediction result and an acoustic feature reference quantity for predicting an audio recognition result; obtaining a second audio prediction result based on the acoustic feature reference quantity; and determining the audio recognition result of the audio to be recognized based on the first audio prediction result and the second audio prediction result, the audio recognition result including unvoiced sound or voiced sound.

According to another aspect of the present disclosure, there is provided an audio recognizing apparatus, including: a predicting module configured to perform acoustic feature prediction on audio to be recognized to obtain a first audio prediction result and an acoustic feature reference quantity for predicting an audio recognition result; and a determining module configured to obtain a second audio prediction result based on the acoustic feature reference quantity, and determine the audio recognition result of the audio to be recognized based on the first audio prediction result and the second audio prediction result, the audio recognition result including unvoiced sound or voiced sound.

According to yet another aspect of the present disclosure, there is provided an electronic device, including: at least one processor; and a memory communicatively connected with the at least one processor; wherein the memory stores instructions executable by the at least one processor, the instructions are executed by the at least one processor to enable the at least one processor to perform any of the audio recognizing method in the above of the present disclosure.

According to yet another aspect of the present disclosure, there is provided a non-transitory computer readable storage medium having stored thereon computer instructions, wherein the computer instructions are used to cause the computer to execute any of the audio recognizing method in the above of the present disclosure.

According to another aspect of the present disclosure, there is provided a computer program product, including a computer program which, when executed by a processor, implements any of the audio recognizing method in the above of the present disclosure.

It should be understood that the content described in this section is not intended to identify key or critical features of embodiments of the present disclosure, nor to limit the scope of the present disclosure. Other features of the present disclosure will become readily understood from the following description.

### BRIEF DESCRIPTION OF THE DRAWINGS

The accompanying drawings are used to better understand the solutions of the present disclosure, and do not constitute a limitation to the present disclosure, in which:

FIG. 1 is a schematic flowchart of an audio recognizing method according to some embodiments of the present disclosure;

FIG. 2 is a schematic flowchart of an audio recognizing method according to some embodiments of the present disclosure;

FIG. 3 is a schematic flowchart of an audio recognizing method according to some embodiments of the present disclosure;

FIG. 4 is a schematic flowchart of obtaining a second audio prediction result based on the acoustic feature reference quantity according to some embodiments of the present disclosure;

FIG. 5 is a block diagram of an audio recognizing apparatus according to some embodiments of the present disclosure; and

FIG. 6 is a block diagram of an electronic device that is used to implement the audio recognizing method according to the embodiments of the present disclosure.

### DETAILED DESCRIPTION OF THE EMBODIMENTS

Exemplary embodiments of the present disclosure are described below with reference to the accompanying drawings, wherein various details of the embodiments of the present disclosure are included so as to facilitate understanding, and they should be considered as exemplary only. Accordingly, as will be appreciated by those of ordinary skill in the art, various changes and modifications may be made to the embodiments described herein without departing from the scope and spirit of the present disclosure. Also, descriptions of commonly-known functions and constructions are omitted from the following description for the sake of clarity and conciseness.

The application of speech synthesis is more and more extensive, its implementation is based on the acoustic model and the vocoder, where the acoustic model converts text or phonemes into acoustic features, and the vocoder converts acoustic features into speech audio.

For the system using the parametric vocoder, the acoustic model can output the unvoiced sound and voiced sound prediction result, the fundamental frequency, the spectral envelope, the energy, and other acoustic parameters obtained from audio prediction. Because of limitations of the acoustic model, there may be errors between the predicted acoustic parameters and the actual numerical values.

When a person makes unvoiced sound, the vocal cords do not vibrate, that is, the fundamental frequency corresponding to vibration should be zero. When the acoustic model is used to predict, the fundamental frequency of the input acoustics includes the fundamental frequency of zero, which will make the fundamental frequency discontinuous and become discrete values, making it difficult for the acoustic model to predict. Moreover, for the acoustic model, the prediction with input of continuous values is simpler than that with input of discrete values. Thus, interpolation is performed on the point whose fundamental frequency is zero by using the fundamental frequency values adjacent to the point whose fundamental frequency is zero, so as to obtain the continuous fundamental frequency, which facilitates predicting by the acoustic model. In the subsequent sound synthesis, the fundamental frequency of the unvoiced part is shielded to obtain the accurate sound.

When a prediction error appears in the prediction result of unvoiced sound and voiced sound, for example, the voiced audio is wrongly determined as unvoiced sound, or the unvoiced audio is wrongly determined as voiced sound, the vocoder uses the prediction result of unvoiced sound and voiced sound to synthesize, which will lead to dumb sound and so on in the synthesized audio due to wrong shielding of the fundamental frequency, such that the quality of sound synthesis is reduced and the user experience is affected.

In view of this, the embodiments of the present disclosure provide an audio recognizing method, to determine that the audio recognition result of the audio to be recognized is unvoiced sound or voiced sound through the result of acoustic feature prediction, based on the audio prediction result combined with other acoustic feature reference quantities, such that the determination result for unvoiced sound or voiced sound of audio is more accurate.

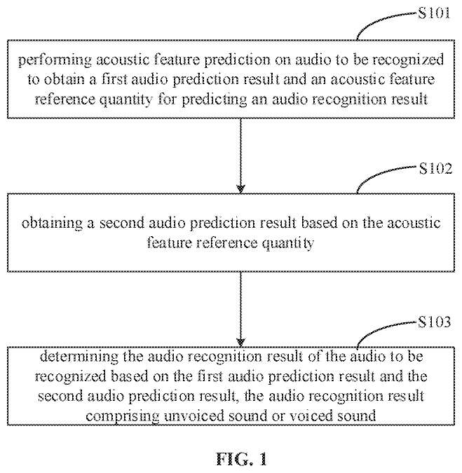

FIG. 1 is a schematic flowchart of an audio recognizing method according to some embodiments of the present disclosure. As shown in FIG. 1, the method according to some embodiments of the present disclosure includes the following steps.

In step S101, acoustic feature prediction is performed on audio to be recognized to obtain a first audio prediction result as well as an acoustic feature reference quantity for predicting an audio recognition result.

In the embodiments of the present disclosure, the acoustic feature prediction on the audio to be recognized can be performed by an acoustic model. The acoustic model performs acoustic feature prediction on the audio to be recognized, obtains the acoustic features of the audio as well as the first audio prediction result. The acoustic feature prediction results of the acoustic model have correspondence at a frame level of the audio. The audio to be recognized can be divided into frames such that the audio to be recognized is divided into different audio frames for processing. The first audio prediction result can be a prediction result determined based on an audio prediction value (uv), where the uv value is used to indicate whether the pronunciation corresponding to the prediction value is unvoiced sound or voiced sound. The corresponding pronunciation is unvoiced sound when the uv value is less than 0, and the corresponding pronunciation is voiced sound when the uv value is greater than 0, where 0 is the critical value for distinguishing unvoiced sound and voiced sound. The acoustic feature reference quantity can be used to predict the audio recognition result. It is understandable that the first audio prediction result and the acoustic feature reference quantity each can determine whether the audio is unvoiced sound or voiced sound.

In step S102, a second audio prediction result is obtained based on the acoustic feature reference quantity.

In step S103, the audio recognition result of the audio to be recognized is determined based on the first audio prediction result and the second audio prediction result, and the audio recognition result includes unvoiced sound or voiced sound.

In the embodiments of the present disclosure, the first audio prediction result as well as other acoustic features of the audio to be recognized can be obtained by performing acoustic feature prediction on the audio to be recognized. The prediction audio recognition result is predicted as unvoiced sound or voiced sound according to inconsistence between the first audio prediction result and the second audio prediction result, but the prediction result may have errors. Based on the acoustic feature reference quantity, the audio to be recognized is recognized for voiced and unvoiced sounds, and the second audio prediction result is obtained to obtain the second audio prediction result. The audio recognition result of the audio to be recognized is determined by combining the first audio prediction result and the second audio prediction result, thereby the first audio prediction result can be effectively revised to make the unvoiced and voiced sound recognition result of the audio to be recognized more accurate.

According to the embodiments of the present disclosure, when performing the recognition for the audio that is unvoiced sound or voiced sound, the result obtained by performing acoustic feature prediction on the audio to be recognized is used, namely, the first audio prediction result is obtained based on the uv value, and the second audio prediction result is obtained in combination with other acoustic feature reference quantity, so as to determine that the audio to be recognized is the unvoiced sound or the voiced sound, thereby making the determination result of unvoiced sound or voiced sound of audio more accurate, to improve the audio quality in speech processing such as speech synthesis etc.

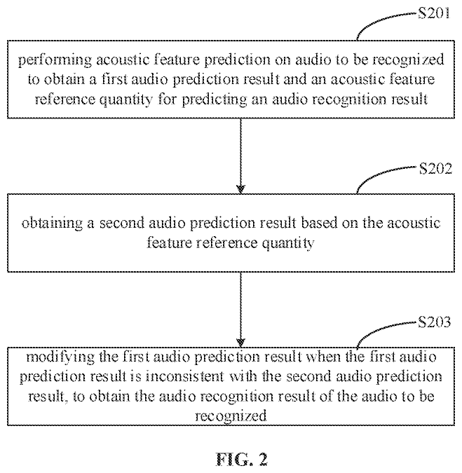

FIG. 2 is a schematic flowchart of an audio recognizing method according to some embodiments of the present disclosure, as shown in FIG. 2, the method according to some embodiments of the present disclosure includes the following steps.

In step S201, acoustic feature prediction is performed on an audio to be recognized to obtain a first audio prediction result as well as an acoustic feature reference quantity for predicting an audio recognition result.

In step S202, a second audio prediction result is obtained based on the acoustic feature reference quantity.

In step S203, the first audio prediction result is revised when the first audio prediction result is inconsistent with the second audio prediction result, to obtain the audio recognition result of the audio to be recognized.

In the embodiments of the present disclosure, audio is recognized to determine the audio recognition result, that is, the output result of the acoustic feature prediction performed on the audio to be recognized, when determining whether the audio is unvoiced sound or voiced sound, that is, the first audio prediction result, as well as the acoustic feature reference quantity are used. The acoustic feature reference quantity can be used to predict the audio recognition result to obtain the second audio prediction result obtained by performing recognition on the audio of the audio to be recognized.

The first audio prediction result is used to characterize whether the audio is unvoiced sound or voiced sound. The audio recognition result of the audio to be recognized is determined based on the first audio prediction result and combined with the second audio prediction result obtained from the acoustic feature reference quantity. If the second audio prediction result is inconsistent with the first audio prediction result, that is, the uv value outputted by the acoustic model may have errors and result in the prediction error of the first audio prediction result, the first audio prediction result is revised to obtain the audio recognition result of the audio to be recognized.

According to the embodiments of the present disclosure, the acoustic feature prediction is performed on the audio to be recognized, and the second audio prediction result is obtained based on the obtained first audio prediction result as well as the acoustic feature reference quantity, thereby the audio recognition result of the audio to be recognized is determined. The first audio prediction result is revised if the second audio prediction result is inconsistent with the first audio prediction result to obtain the audio recognition result of the audio to be recognized, such that the determination result is more accurate, thereby the audio quality in speech processing such as speech synthesis etc. is improved.

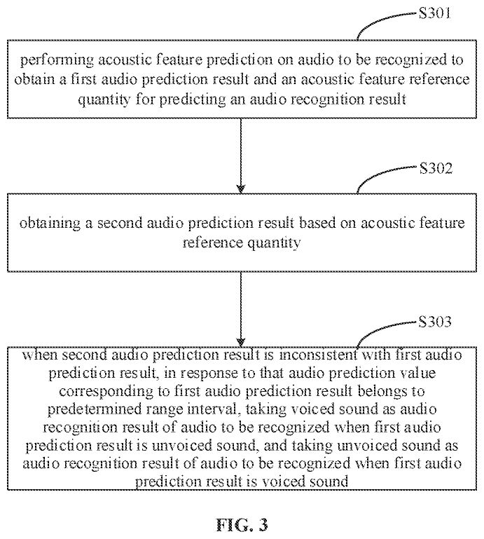

FIG. 3 is a schematic flowchart of an audio recognizing method according to some embodiments of the present disclosure. As shown in FIG. 3, the method according to some embodiments of the present disclosure includes the following steps.

In step S301, acoustic feature prediction is performed on an audio to be recognized to obtain a first audio prediction result as well as an acoustic feature reference quantity for predicting an audio recognition result.

In step S302, a second audio prediction result is obtained based on the acoustic feature reference quantity.

In step S303, when the second audio prediction result is inconsistent with the first audio prediction result, in response to that an audio prediction value corresponding to the first audio prediction result belongs to a predetermined range interval, the voiced sound is taken as the audio recognition result of the audio to be recognized when the first audio prediction result is the unvoiced sound, and the unvoiced sound is taken as the audio recognition result of the audio to be recognized when the first audio prediction result is the voiced sound.

In the embodiments of the present disclosure, the audio to be recognized is recognized to determine the audio recognition result, that is, to determine whether the audio is unvoiced sound or voiced sound. The audio recognition result of the audio to be recognized is determined based on the first audio prediction result and in combination with the other acoustic feature reference quantities. If the second prediction result based on the acoustic feature reference quantity is inconsistent with the first audio prediction result, for example, the second prediction result obtained based on the acoustic feature reference quantity is the unvoiced sound whereas the first audio prediction result is the voiced sound, or the second prediction result obtained based on the acoustic feature reference quantity is the voiced sound whereas the first audio prediction result is the unvoiced sound, there may be errors in the first audio prediction result. The first audio prediction result is revised to obtain the audio recognition result of the audio to be recognized.

In the embodiments of the present disclosure, the first audio prediction result is determined by using the uv value outputted by the acoustic model. Within syllables in the audio, the uv value outputted by the acoustic model can be a positive value or a negative value, and the greater the absolute value of the positive value or the negative value, the lower the probability of prediction errors in the prediction based on the uv value. At the boundary between voiced syllables and unvoiced syllables in the audio, the predicted uv value is predicted to be a numerical value close to the critical value of zero, and can be a positive value or a negative value. To sum up, near the syllable boundary, that is, when the predicted uv value is close to zero, the prediction errors of the first audio prediction result determined based on the uv value are more likely to occur.

When the first audio prediction result is inconsistent with the second audio prediction result, the uv value corresponding to the first audio prediction result is further determined, that is, it is determined whether the uv value belongs to the predetermined range interval. The predetermined range interval can be an interval with a critical value as the interval midpoint and a predetermined value as the interval endpoint, and the interval endpoint is close to the interval midpoint. It is understandable that the predetermined range interval can be determined according to the actual use requirements per se. In the case where the first audio prediction result is inconsistent with the second audio prediction result, the uv value belongs to the predetermined range interval, the voiced sound is taken as the audio recognition result of the audio to be recognized if the first audio prediction result is unvoiced sound, and the unvoiced sound is taken as the audio recognition result of the audio to be recognized if the first audio prediction result is voiced sound.

According to the embodiments of the present disclosure, the acoustic feature prediction is performed on the audio to be recognized. Based on the obtained audio prediction result, if the first audio prediction result is inconsistent with the second audio prediction result, and the uv value belongs to the predetermined range interval, the first audio prediction result is adjusted, and the adjusted first audio prediction result is used as the audio recognition result of the audio to be recognized, such that the determination result is more accurate, thereby the audio quality in speech processing such as speech synthesis etc. is improved.

In an exemplary implementation of the present disclosure, the acoustic feature prediction is performed on the audio to be recognized by an acoustic model to obtain the acoustic features of the audio. For example, the acoustic feature can be fundamental frequency, spectrum distribution, energy, pitch period, the audio prediction result of unvoiced sound and voiced sound, etc. It can be based on the spectrum distribution average value and the energy value, which serve as the reference value for unvoiced sound and voiced sound recognition of the audio, and the audio prediction result outputted by the acoustic model can be revised to obtain the accurate result of unvoiced sound and voiced sound recognition of the audio to be recognized. Meanwhile, the second audio prediction result is obtained based on the spectrum distribution average value and the energy value, and the first audio prediction result is checked in combination with the second audio prediction result. When the results are inconsistent, the first audio prediction result is revised, which can make the determination result of unvoiced sound or voiced sound of the audio more accurate.

FIG. 4 is a schematic flowchart of obtaining a second audio prediction result based on the acoustic feature reference quantity according to some embodiments of the present disclosure. As shown in FIG. 4, the method according to some embodiments of the present disclosure includes the following steps.

In step S401, it is determined that the second audio prediction result for predicting the audio to be recognized is the voiced sound if the distribution average value of the spectrum distribution in a first frequency range is smaller than a first predetermined threshold value and the energy value is larger than a third predetermined threshold value, wherein the first frequency range is a range lower than a first predetermined frequency in the spectrum distribution.

In step S402, it is determined that the second audio prediction result for predicting the audio to be recognized is the unvoiced sound if the distribution average value of the spectrum distribution in a second frequency range is greater than a second predetermined threshold and the energy value is less than or equal to the third predetermined threshold, wherein the second frequency range is a range higher than a second predetermined frequency in the spectrum distribution.

In the embodiments of the present disclosure, the spectrum distribution of the audio is obtained by performing the acoustic feature prediction on the audio to be recognized by the acoustic model. The spectrum is a representation in the frequency domain of signals in the time domain, and can be obtained by performing Fourier transform on signals, and the spectrum can indicate which frequencies of sine waves a signal is composed of. The first prediction result of unvoiced sound and voiced sound prediction of the audio to be recognized is determined through spectrum distribution. The audio signal can be filtered by a multi-subband filter, and the frequency domain information of the audio signal can be obtained by the transformation from the time domain to the frequency domain. The spectrum distribution of the audio spectrum in respective frequency ranges can be determined respectively according to different frequency ranges.

It is understandable that there are differences in spectrum distribution of the unvoiced sound and the voiced sound, where the energy is concentrated in the high frequency range in spectrum distribution of the unvoiced sound, whereas the energy is concentrated in the middle and low frequency ranges in spectrum distribution of the voiced sound. Thus, the first prediction result as to whether the audio to be recognized is unvoiced sound or voiced sound can be determined by the spectrum distribution average value.

In an exemplary implementation of the present disclosure, the first prediction result can be determined by determining the distribution average value in the spectrum distribution that is lower than the first frequency range, that is, the distribution average value corresponding to the low frequency bands. For example, for all frequency bands in the spectrum distribution, the frequency bands in the range lower than the first predetermined frequency are determined as the low-dimensional frequency bands, and the frequency bands in the range higher than the second predetermined frequency are determined as the high-dimensional frequency bands, where the first predetermined frequency is smaller than the second predetermined frequency. It is determined that the first prediction result for predicting the audio to be recognized is the voiced sound if the distribution average value of the low-dimensional frequency bands is less than the first predetermined threshold; and it is determined that the first prediction result for predicting the audio to be recognized is the unvoiced voice if the distribution average value of the low-dimensional frequency bands of the spectrum distribution is greater than or equal to the first predetermined threshold. The first prediction result can also be determined by determining the high-dimensional frequency band distribution average value of the spectrum distribution. It is determined that the first prediction result for predicting the audio to be recognized is the unvoiced sound if the average value of high-dimensional frequency band distribution of the spectrum distribution is greater than the second predetermined threshold; and it is determined that the first prediction result for predicting the audio to be recognized is the voiced sound if the average value of high-dimensional frequency band distribution of the spectrum distribution is less than or equal to the second predetermined threshold.

In the embodiments of the present disclosure, the acoustic features of the audio to be recognized are predicted by the acoustic model, and the energy value corresponding to the audio is obtained. The audio signal of the audio to be identified is filtered by a multi-subband filter, and the spectral energy value is determined through the spectrum of the audio signal. There are numerical differences in the distribution of spectral energy values between the unvoiced sound and the voiced sound. Thus, the second prediction result that the audio to be recognized is the unvoiced sound or the voiced sound can be determined through the energy value.

In an exemplary implementation of the present disclosure, the spectral energy value can be determined to determine the second prediction result. It is determined that the second prediction result for predicting the audio to be recognized is the voiced sound if the spectral energy value is greater than the third predetermined threshold; and it is determined that the second prediction result for predicting the audio to be recognized is the unvoiced sound if the spectral energy value is less than or equal to the third predetermined threshold.

In the embodiments of the present disclosure, the first prediction result that the audio to be recognized is the unvoiced sound or the voiced sound is determined by the spectrum distribution average value; and the second prediction result that the audio to be recognized is the unvoiced sound or the voiced sound is determined through the energy value. The audio recognition result of the audio to be recognized is determined based on the first prediction result, the second prediction result and the audio prediction result. For example, it is determined by the first prediction result that the audio to be recognized is the unvoiced sound, it is determined by the second prediction result that the audio to be recognized is the unvoiced sound, and it is determined by the audio prediction result that the audio to be recognized is the voiced sound, the first prediction result and the second prediction result are consistent and inconsistent with the audio prediction result, then the audio prediction result is revised to obtain the audio recognition result of the audio to be recognized.

When the second audio prediction result is obtained based on the spectrum distribution average value and the energy value, it is determined that the second audio prediction result for predicting the audio to be recognized is the voiced sound if the low-dimensional frequency band distribution average value of the spectrum distribution is smaller than the first predetermined threshold and the energy value is larger than the third predetermined threshold. It is determined that the second audio prediction result for predicting the audio to be recognized is the unvoiced sound if the average value of the high-dimensional frequency band distribution of the spectrum distribution is greater than the second predetermined threshold and the energy value is less than or equal to the third predetermined threshold.

According to the embodiments of the present disclosure, the acoustic feature prediction is performed on the audio to be recognized, the first audio prediction result is obtained based on the uv value, and the second audio prediction result is obtained based on the spectrum distribution average value and the energy value. The audio prediction result is revised when the first audio prediction result is inconsistent with the second audio prediction result, to obtain the audio recognition result of the audio to be recognized, such that the determination result is made more accurate, and thus the audio quality in speech processing such as speech synthesis etc. is improved.

In an implementation, the acoustic feature prediction is performed on the audio to be recognized by an acoustic model. The acoustic model outputs the audio prediction result used to predict the audio recognition result, the spectrum distribution average value and the energy value, and revises the audio prediction result based on the prediction result obtained through the spectrum distribution average value and the energy value, so as to obtain the accurate audio recognition result of the audio to be recognized. The audio signal of the audio to be identified is filtered by a multi-subband filter, and the frequency domain information of the audio signal is obtained by the transformation from the time domain to the frequency domain. The low-dimensional frequency band distribution average value of the spectrum distribution is judged to determine the first prediction result of the audio to be recognized, and the spectrum energy value is judged to determine the second prediction result.

It can be carried out based on the following manners. It is determined that the first prediction result for predicting the audio to be recognized is the voiced sound if the low-dimensional frequency band distribution average value of the spectrum distribution is less than the first predetermined threshold; and it is further determined that the second prediction result of the audio to be recognized is the voiced sound if the spectrum energy value is greater than the third predetermined threshold. That is, the first prediction result for predicting the audio to be recognized is consistent with the second prediction result for predicting the audio to be recognized. If it is determined by the audio prediction result that the audio to be recognized is the unvoiced sound, it is inconsistent with the above first and second prediction results. In this case, if the audio prediction result belongs to the predetermined range interval, which is the interval distributed near the critical point for distinguishing between the unvoiced sound and the voiced sound, the audio prediction result is adjusted, that is, the result thereof is adjusted to the voiced sound, and it is determined that the audio recognition result of the audio to be recognized is the voiced sound.

It is understandable that in the case where the first prediction result for predicting the audio to be recognized is consistent with the second prediction result for predicting the audio to be recognized, both of which are the unvoiced sound, if it is determined by the audio prediction result that the audio to be recognized is the voiced sound, the audio prediction result is adjusted to the unvoiced sound, and the audio recognition result of the audio to be recognized is determined to be the unvoiced sound.

According to the embodiments of the present disclosure, when performing recognition as to the audio is unvoiced sound or voiced sound, a result determination is made in combination with the acoustic feature reference quantity obtained by acoustic feature prediction, that is, it is determined that the audio to be recognized is unvoiced sound or voiced sound based on the acoustic feature reference quantity and the audio prediction result, such that the determination result of unvoiced sound or voiced audio is more accurate, thereby the audio quality in speech processing such as speech synthesis etc. is improved.

In an exemplary implementation of the present disclosure, the first audio prediction result is determined based on the uv value corresponding to the audio to be recognized, and the second audio prediction result is obtained based on the spectral distribution average value and the energy value. When the audio recognition result of the audio to be recognized is determined based on the first audio prediction result and the second audio prediction result, it can also be realized by the following ways. The spectrum distributions of the unvoiced sound and the voiced sound are different, and the first prediction result determined based on uv value can be revised by the numerical value of the spectrum distribution average value. For example, for the first audio to be recognized, when the low-dimensional frequency band distribution average value of its spectrum distribution is less than the first threshold, the audio is determined as the voiced sound. For the second audio to be recognized, when the low-dimensional frequency band distribution average value of its spectrum distribution is less than the second threshold, the audio is determined as voiced sound, and the absolute value of the first threshold is greater than the absolute value of the second threshold. When the first audio prediction results of the first audio to be recognized and the second audio to be recognized are revised, the revising manners are different. That is, for the first audio to be recognized, when the low-dimensional frequency band distribution average value of the spectrum distribution thereof is smaller than the first threshold and the energy value is larger than the third threshold, it is determined as the voiced sound. When it is further determined that the uv value is greater than the fourth threshold, the first audio prediction result determined based on the uv value is revised. For the second audio to be recognized, when the low-dimensional frequency band distribution average value of the spectrum distribution thereof is less than the second threshold and the energy value is greater than the third threshold, it is determined as the voiced sound. When the uv value is further determined to be greater than the fifth threshold, the first audio prediction result determined based on the uv value is revised. Herein, the absolute value of the fourth threshold is greater than that of the fifth threshold such that the first audio prediction result can be revised more accurately.

For example, for the first audio to be recognized, when the low-dimensional frequency band distribution average value of the spectrum distribution thereof is less than −15 and the energy value is greater than 0, the second audio prediction result of voiced sound is obtained. When the uv value of the audio is greater than −5, the first audio prediction result is revised, that is, the first audio prediction result is determined to be the voiced sound; if the uv value of the audio is less than or equal to −5, the first audio prediction result is not revised. For the second audio to be recognized, when the low-dimensional frequency band distribution average value of the spectrum distribution thereof is less than −9 and the energy value is greater than 0, the second audio prediction result is the voiced sound. When the uv value of the audio is greater than −3, the first audio prediction result is revised, that is, the first audio prediction result is determined as the voiced sound.

Based on similar concept, the embodiments of the present disclosure further provide an audio recognizing apparatus.

It can be understood that, in order to realize the above functions, the apparatus provided by the embodiments of the present disclosure includes corresponding hardware structures and/or software modules for executing the respective functions. In combination with the units and algorithm steps of the respective examples disclosed in the embodiments of the present disclosure, the embodiments of the present disclosure can be implemented in the form of hardware or a combination of hardware and computer software. As for whether a certain function is performed by hardware or in the manner of computer software driving hardware, it depends on the specific application and design constraint of the technical solutions. Those skilled in the art can use different methods to realize the described functions for each specific application, but this realization should not be considered beyond the scope of the technical solutions of the embodiments of the present disclosure.

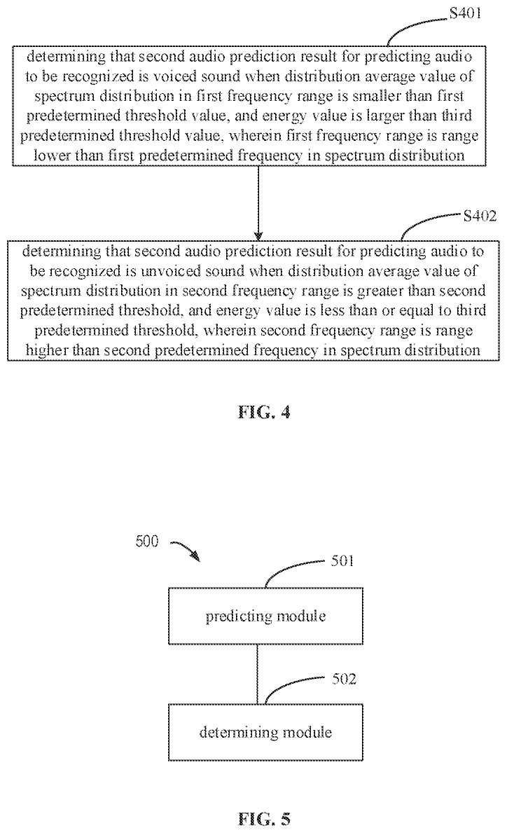

FIG. 5 is a block diagram of an audio recognizing apparatus according to some embodiments of the present disclosure.

As shown in FIG. 5, the audio recognizing apparatus 600 according to the embodiments of the present disclosure includes a predicting module 501 and a determining module 502.

The predicting module 501 is configured to perform acoustic feature prediction on audio to be recognized to obtain a first audio prediction result as well as an acoustic feature reference quantity for predicting an audio recognition result.

The determining module 502 is configured to obtain a second audio prediction result based on the acoustic feature reference quantity, and determine the audio recognition result of the audio to be recognized based on the first audio prediction result and the second audio prediction result, and the audio recognition result includes the unvoiced sound or the voiced sound.

In an exemplary implementation of the present disclosure, the determining module 502 is further configured to: revise the first audio prediction result if the first audio prediction result is inconsistent with the second audio prediction result, to obtain the audio recognition result of the audio to be recognized.

In an exemplary implementation of the present disclosure, the determining module 502 is further configured to: in response to that an audio prediction value corresponding to the first audio prediction result belongs to a predetermined range interval, take the voiced sound as the audio recognition result of the audio to be recognized if the first audio prediction result is the unvoiced sound, and take the unvoiced sound as the audio recognition result of the audio to be recognized if the first audio prediction result is the voiced sound.

In an exemplary implementation of the present disclosure, the acoustic feature reference quantity includes an average value of spectrum distribution and an energy value.

In an exemplary implementation of the present disclosure, the determining module 502 is further configured to: determine that the second audio prediction result for predicting the audio to be recognized is the voiced sound if the distribution average value of the spectrum distribution in a first frequency range is smaller than a first predetermined threshold value and the energy value is larger than a third predetermined threshold value, where the first frequency range is a range lower than a first predetermined frequency in the spectrum distribution; and determine that the second audio prediction result for predicting the audio to be recognized is the unvoiced sound if the distribution average value of the spectrum distribution in a second frequency range is greater than a second predetermined threshold and the energy value is less than or equal to the third predetermined threshold, where the second frequency range is a range higher than a second predetermined frequency in the spectrum distribution.

To sum up, the audio recognizing apparatus according to the embodiments of the present disclosure, when determining whether the audio is unvoiced sound or voiced sound, can use the result obtained by performing acoustic feature prediction on the audio to be recognized, namely, based on the first audio prediction result, and in combination with other acoustic feature reference quantity to obtain the second audio prediction result, so as to determine that the audio to be recognized is the unvoiced sound or the voiced sound, thereby making the determination result of unvoiced sound or voiced sound of audio more accurate, to improve the audio quality in speech processing such as speech synthesis.

According to the embodiments of the present disclosure, the present disclosure further provides an electronic device, a readable storage medium, and a computer program product.

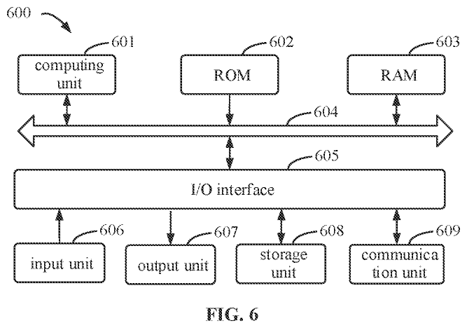

FIG. 6 shows a schematic block diagram of an example electronic device 600 that can be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile devices, such as personal digital assistants, cellular phones, smart phones, wearable devices, and other similar computing devices. The components shown herein, their connections and relationships, and their functions are only examples, and are not intended to limit the implementations of the present disclosure described and/or claimed herein.

As shown in FIG. 6, the device 600 includes a computing unit 601, which can perform various appropriate actions and processes according to a computer program stored in a read only memory (ROM) 602 or a computer program loaded from a storage unit 608 into a random access memory (RAM) 603. Various programs and data required for the operations of the device 600 can also be stored in the RAM 603. The computing unit 601, the ROM 602, and the RAM 603 are connected to each other through a bus 604. An input/output (I/O) interface 605 is also connected to the bus 604.

A number of components in the device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the device 600 to exchange information/data with other devices through a computer network such as Internet and/or various telecommunication networks.

The computing unit 601 can be various general-purpose and/or special-purpose processing components with processing and computing capabilities. Some examples of the computing unit 601 include, but are not limited to: a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 601 executes the various methods and processes described above, such as the audio recognizing method. For example, in some embodiments, the audio recognizing method can be implemented as a computer software program tangibly embodied in a machine-readable medium such as the storage unit 608. In some embodiments, all or part of the computer program can be loaded and/or installed on the device 600 via the ROM 602 and/or the communication unit 609. When the computer program is loaded into the RAM 603 and executed by the computing unit 601, one or more steps of the audio recognizing method described above can be performed. Alternatively, in other embodiments, the computing unit 601 can be configured to perform the audio recognizing method by any other suitable means (for example, by means of firmware).

Various implementations of the systems and techniques described herein above can be implemented in digital electronic circuit system, integrated circuit system, field programmable gate array (FPGA), application specific integrated circuit (ASIC), application specific standard product (ASSP), system on chip (SOC), load programmable logic device (CPLD), computer hardware, firmware, software, and/or combinations thereof. These various implementations can include: being implemented in one or more computer programs that can be executed and/or interpreted on a programmable system that includes at least one programmable processor, the programmable processor can be a special-purpose or general-purpose programmable processor that can receive data and instructions from and transmit data and instructions to a storage system, at least one input device, and at least one output device.

The program code for implementing the method of the present disclosure can be compiled in any combination of one or more programming languages. These program codes can be provided to the processors or controllers of general-purpose computers, special-purpose computers or other programmable data processing devices, such that when executed by the processors or controllers, the program codes cause the functions/operations specified in the flowcharts and/or block diagrams to be implemented. The program code can be completely executed on the machine, partially executed on the machine, partially executed on the machine as a stand-alone software package and partially executed on a remote machine, or completely executed on a remote machine or server.

In the context of this disclosure, the machine-readable medium can be a tangible medium that can contain or store a program for use by or in connection with an instruction execution system, apparatus or device. The machine-readable medium can be a machine-readable signal medium or a machine-readable storage medium. The machine-readable media can include, but are not limited to, electronic, magnetic, optical, electromagnetic, infrared, or semiconductor systems, devices or devices, or any suitable combination of the aforesaid content. More specific examples of the machine-readable storage media will include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the aforesaid content.

In order to provide interaction with the user, the systems and techniques described herein can be implemented on a computer, the computer has: a display device (e.g., CRT (Cathode Ray Tube) or LCD (Liquid Crystal Display) monitor) for displaying information to the user; and a keyboard and a pointing device (e.g., a mouse or a trackball) through which the user can provide input to the computer. Other kinds of devices can also be used to provide interaction with the user; for example, the feedback provided to the user can be any form of sensory feedback (e.g., visual feedback, auditory feedback, or tactile feedback); and the input from the user can be received in any form (including acoustic input, voice input, or tactile input).

The systems and techniques described herein can be implemented in a computing system that includes back-end components (e.g., as a data server), or a computing system that includes middleware components (e.g., an application server), or a computing system that includes front-end components (e.g., a user computer with a graphical user interface or a web browser through which the user can interact with the implementations of the systems and technologies described herein), or a computing system that includes any combinations of such back-end components, middleware components, or front-end components. The components of the system can be connected to each other by digital data communication in any form or medium (e.g., communication network). Examples of the communication network include: local area network (LAN), wide area network (WAN) and Internet.

A computer system can include a client and a server. The client and the server are usually far away from each other and usually interact through the communication network. The relationship between the client and the server is generated by computer programs running on the corresponding computers and having a client-server relationship with each other. The server can be a cloud server, a distributed system server, or a server combined with blockchain.

According to the technical solutions provided by the embodiments of the present disclosure, when determining whether the audio is the unvoiced sound or the voiced sound, the present disclosure can use the result obtained by performing acoustic feature prediction on the audio to be recognized, namely, based on the first audio prediction result, and in combination with other acoustic feature reference quantity to obtain the second audio prediction result, so as to determine that the audio to be recognized is the unvoiced sound or the voiced sound, thereby making the determination result of unvoiced sound or voiced sound of the audio more accurate, to improve the audio quality in speech processing such as speech synthesis.

It should be understood that steps can be reordered, added or deleted using the various forms of processes shown above. For example, the respective steps described in the present disclosure can be executed in parallel, in sequence or in different orders, so long as the desired results of the technical solutions disclosed in the present disclosure can be achieved, there is no limitation herein.

The above specific implementations do not constitute limitation to the protection scope of the present disclosure. Those skilled in the art should understand that various modifications, combinations, sub-combinations and substitutions can be made according to design requirement and other factors. Any modification, equivalent substitution and improvement made within the spirit and principle of the present disclosure shall be included in the protection scope of the present disclosure.

What is claimed is:

1. An audio recognizing method, comprising:
performing acoustic feature prediction on the audio to be recognized to obtain a first audio prediction result and an acoustic feature reference quantity for predicting an audio recognition result;
obtaining a second audio prediction result based on the acoustic feature reference quantity; and
determining the audio recognition result of the audio to be recognized based on the first audio prediction result and the second audio prediction result, the audio recognition result comprising unvoiced sound or voiced sound.

2. The method according to claim 1, wherein the determining the audio recognition result of the audio to be recognized based on the first audio prediction result and the second audio prediction result comprises:
revising the first audio prediction result when the first audio prediction result is inconsistent with the second audio prediction result, to obtain the audio recognition result of the audio to be recognized.

3. The method according to claim 2, wherein the revising the first audio prediction result to obtain the audio recognition result of the audio to be recognized comprises:
in response to that an audio prediction value corresponding to the first audio prediction result belongs to a predetermined range interval, taking the voiced sound as the audio recognition result of the audio to be recognized when the first audio prediction result is the unvoiced sound, and taking the unvoiced sound as the audio recognition result of the audio to be recognized when the first audio prediction result is the voiced sound.

4. The method according to claim 1, wherein the acoustic feature reference quantity comprises a spectrum distribution average value and an energy value.

5. The method according to claim 4, wherein the obtaining a second audio prediction result based on the acoustic feature reference quantity comprises:
determining that the second audio prediction result for predicting the audio to be recognized is the voiced sound when the distribution average value of the spectrum distribution in a first frequency range is smaller than a first predetermined threshold value, and the energy value is larger than a third predetermined threshold value, wherein the first frequency range is a range lower than a first predetermined frequency in the spectrum distribution; and
determining that the second audio prediction result for predicting the audio to be recognized is the unvoiced sound when the distribution average value of the spectrum distribution in a second frequency range is greater than a second predetermined threshold, and the energy value is less than or equal to the third predetermined threshold, wherein the second frequency range is a range higher than a second predetermined frequency in the spectrum distribution.

6. An audio recognizing apparatus, comprising:
a predicting circuit configured to perform acoustic feature prediction on the audio to be recognized to obtain a first audio prediction result and an acoustic feature reference quantity for predicting an audio recognition result; and
a determining circuit configured to obtain a second audio prediction result based on the acoustic feature reference quantity, and determine the audio recognition result of the audio to be recognized based on the first audio prediction result and the second audio prediction result, the audio recognition result comprising unvoiced sound or voiced sound.

7. The apparatus according to claim 6, wherein the determining circuit is further configured to:
modify the first audio prediction result when the first audio prediction result is inconsistent with the second audio prediction result, to obtain the audio recognition result of the audio to be recognized.

8. The apparatus according to claim 7, wherein the determining circuit is further configured to:
in response to that an audio prediction value corresponding to the first audio prediction result belongs to a predetermined range interval, take the voiced sound as the audio recognition result of the audio to be recognized when the first audio prediction result is the unvoiced sound, and take the unvoiced sound as the audio recognition result of the audio to be recognized when the first audio prediction result is voiced sound.

9. The apparatus according to claim 6, wherein the acoustic feature reference quantity comprises a spectrum distribution average value and an energy value.

10. The apparatus according to claim 9, wherein the determining circuit is further configured to:
determine that the second audio prediction result for predicting the audio to be recognized is the voiced sound when the distribution average value of the spectrum distribution in a first frequency range is smaller than a first predetermined threshold value and the energy value is larger than a third predetermined threshold value, wherein the first frequency range is a range lower than a first predetermined frequency in the spectrum distribution; and
determine that the second audio prediction result for predicting the audio to be recognized is the unvoiced sound when the distribution average value of the spectrum distribution in a second frequency range is greater than a second predetermined threshold and the energy value is less than or equal to the third predetermined threshold, wherein the second frequency range is a range higher than a second predetermined frequency in the spectrum distribution.

11. An electronic device, comprising:
at least one processor; and
a memory communicatively connected with the at least one processor;
wherein the memory stores instructions executable by the at least one processor, the instructions are executed by the at least one processor to enable the at least one processor to perform the audio recognizing method according to claim 1.

12. A non-transitory computer readable storage medium having stored thereon computer instructions, wherein the computer instructions are used to cause the computer to execute the audio recognizing method according to claim 1.

13. The storage medium according to claim 12, wherein the determining the audio recognition result of the audio to be recognized based on the first audio prediction result and the second audio prediction result comprises:
revising the first audio prediction result when the first audio prediction result is inconsistent with the second audio prediction result, to obtain the audio recognition result of the audio to be recognized.

14. The storage medium according to claim 13, wherein the revising the first audio prediction result to obtain the audio recognition result of the audio to be recognized comprises:
in response to that an audio prediction value corresponding to the first audio prediction result belongs to a predetermined range interval, taking the voiced sound as the audio recognition result of the audio to be recognized when the first audio prediction result is the unvoiced sound, and taking the unvoiced sound as the audio recognition result of the audio to be recognized when the first audio prediction result is the voiced sound.

15. The storage medium according to claim 12, wherein the acoustic feature reference quantity comprises a spectrum distribution average value and an energy value.

16. A computer program product, comprising a computer program which, when executed by a processor, implements the audio recognizing method according to claim 1.

17. The computer program product according to claim 16, wherein the determining the audio recognition result of the audio to be recognized based on the first audio prediction result and the second audio prediction result comprises:
revising the first audio prediction result when the first audio prediction result is inconsistent with the second audio prediction result, to obtain the audio recognition result of the audio to be recognized.

18. The computer program product according to claim 17, wherein the revising the first audio prediction result to obtain the audio recognition result of the audio to be recognized comprises:
in response to that an audio prediction value corresponding to the first audio prediction result belongs to a predetermined range interval, taking the voiced sound as the audio recognition result of the audio to be recognized when the first audio prediction result is the unvoiced sound, and taking the unvoiced sound as the audio recognition result of the audio to be recognized when the first audio prediction result is the voiced sound.

19. The computer program product according to claim 16, wherein the acoustic feature reference quantity comprises a spectrum distribution average value and an energy value.

20. The computer program product according to claim 19, wherein the obtaining a second audio prediction result based on the acoustic feature reference quantity comprises:
determining that the second audio prediction result for predicting the audio to be recognized is the voiced sound when the distribution average value of the spectrum distribution in a first frequency range is smaller than a first predetermined threshold value, and the energy value is larger than a third predetermined threshold value, wherein the first frequency range is a range lower than a first predetermined frequency in the spectrum distribution; and
determining that the second audio prediction result for predicting the audio to be recognized is the unvoiced sound when the distribution average value of the spectrum distribution in a second frequency range is greater than a second predetermined threshold, and the energy value is less than or equal to the third predetermined threshold, wherein the second frequency range is a range higher than a second predetermined frequency in the spectrum distribution.
